(19) United States
(12) Patent Application Publication
(10) Pub. No.: US 2025/0100596 A1
(43) Pub. Date: Mar. 27, 2025

(54) RAIL LIGHTING FIXTURE AND METHOD FOR MANUFACTURE THEREOF

(71) Applicants: M.B. BROEKHUIS BEHEER B.V., THE HAGUE (NL); MRNP HOLDING B.V., SCHALKHAAR (NL)

(72) Inventor: Martijn Bastiaan BROEKHUIS, THE HAGUE (NL)

(73) Assignees: M.B. BROEKHUIS BEHEER B.V., THE HAGUE (NL); MRNP HOLDING B.V., SCHALKHAAR (NL)

(21) Appl. No.: 18/859,326

(22) PCT Filed: Apr. 25, 2023
(86) PCT No.: PCT/EP2023/060846

§ 371 Date: Oct. 23, 2024

(30) Foreign Application Priority Data
Apr. 25, 2022 (NL) 2031698
Jun. 22, 2022 (NL) 2032257
Nov. 29, 2022 (NL) 2033637

(51) Int. Cl. B61L 9/04; B61L 23/06

(52) U.S. Cl. CPC B61L 9/04; B61L 23/06

(57) ABSTRACT

A rail lighting fixture for providing illumination along a rail of a railway track includes a housing arranged for attachment to the rail and provided with at least one aperture. At least one light source is provided in the housing and arranged to emit a light beam. The lighting fixture is arranged to direct the light beam through the aperture towards a lighting direction, and the lighting direction has a component that is parallel to a longitudinal direction of the rail.

The present invention relates to a rail lighting fixture for providing illumination along a rail of a railway track, in particular a train track, wherein the lighting fixture comprises a housing, arranged for attachment to the rail, and at least one light source arranged to emit a light beam. The present invention further relates to a method of manufacturing such a rail lighting fixture.

Such a lighting fixture is for instance known from European patent publication No. 3 251 916, which discloses a lighting fixture for illuminating part of a track on a railway of I-type rails, wherein the lighting fixture comprises an elongated housing, which has a mounting surface arranged for attachment to the body of a rail in lengthwise direction of the rail, and an array of light sources which are distributed in lengthwise direction over the housing and which emit light in a direction traverse to and away from the rail.

Often, to illuminate an elongated part of a track along a rail, such known lighting fixtures are about 2 metres in length, wherein an array of lighting fixtures is attached along a rail at intervals of about 4 metres, such that the lighting fixtures are spaced at a mutual distance of about 2 metres in lengthwise direction of the rail. However, the manufacture of such bulky lighting fixtures is material-intensive. Furthermore, installation of the known lighting fixtures is labour-intensive, in particular if a large number thereof is to be installed, thus impeding the throughput of trains or other railway vehicles.

A further disadvantage of the known lighting fixture is that a person near the track can be blinded by the light.

It is an object of the present invention to provide an improved rail lighting fixture wherein the aforesaid drawbacks are at least partially alleviated.

Thereto, a lighting fixture for providing illumination along a rail of a railway track, wherein the lighting fixture comprises a housing, arranged for attachment to the rail and provided with at least one aperture, and at least one light source provided in the housing and arranged to emit a light beam, wherein the lighting fixture is arranged to direct the light beam through the aperture towards a lighting direction, wherein the lighting direction has a component that is parallel to a longitudinal direction of the rail. For instance, the lighting direction is parallel to the longitudinal direction. To illuminate a path alongside the rail, the light beam is for instance wide, such that the light beam, directed towards the lighting direction parallel to the longitudinal direction of the rail, is partially directed away from the rail to illuminate a path over a sufficient width thereof. Alternatively, or additionally, the light beam illuminates a length section of the rail, such that the path alongside the rail is illuminated indirectly via the rail. Particularly in that case, the path can be illuminated in a manner visually pleasant to a person near the track.

By directing the light beam towards a lighting direction parallel to the longitudinal direction of the rail, blinding of persons can be reduced relative to a lighting fixture emitting light in a direction traverse to and away from the rail.

It is to be appreciated that, as the light beam is directed towards a lighting direction parallel to the longitudinal direction of the rail, the light beam is not necessarily solely directed in a direction that is precisely parallel to the rail. It can be envisaged that, for illuminating a part of a rail and/or a path along the rail, the light beam may diverge and/or at least partially deviate from the direction that is precisely parallel to the rail, while being directed in a direction approximately parallel to the rail.

To illuminate an elongated part of a track along a rail, the aforenoted known lighting fixture, which emits light in a direction traverse to and away from the rail, comprises an array of light sources distributed in lengthwise direction over an elongated housing. By arranging the lighting fixture to direct a light beam in a longitudinal direction of the rail, a compact lighting fixture can be provided which is material-efficient and lightweight, thereby reducing manufacturing costs and installation time relative to the known lighting fixtures. Furthermore, compactness of the lighting fixture facilitates installation of the lighting fixture at or near a railroad switch and/or junction, or any curved railroad section.

Furthermore, when an array of the lighting fixtures is attached along a rail at intervals, the track can be illuminated more uniformly relative to an array of lighting fixtures emitting light in a direction traverse to and away from the rail, especially when the illumination distributions, respectively provided in the longitudinal direction by consecutive lighting fixtures in the array, at least partially overlap.

To illuminate the track even more uniformly with such an array, and/or to enable a reduction in the number of lighting fixtures in the array, the lighting fixture is preferably arranged to direct a first light beam and a second light beam towards mutually opposite lighting directions parallel to the longitudinal direction. More generally, by emitting opposite light beams, the lighting fixture can efficiently illuminate an elongated part along the rail.

For instance, the housing may be provided with at least two apertures, wherein the lighting fixture comprises at least two light sources provided in the housing and arranged to emit respective light beams, wherein the lighting fixture is arranged to direct the respective light beams through the respective apertures towards the respective lighting directions. Alternatively, a single light source may be arranged to emit the respective light beams.

The rail lighting fixture may be further arranged to direct a light beam towards a traverse lighting direction, wherein the traverse lighting direction is traverse to the longitudinal direction of the rail. Thereto, the rail lighting fixture may comprise a side light source, such as a LED, arranged to emit a light beam in the traverse lighting direction. The side light source is preferably arranged on a side of the housing opposite to the side of the housing attached to the rail.

To further reduce blinding of persons, the housing is preferably provided with at least one recess, wherein the at least one light source is provided in the at least one recess. In addition, a compact rail lighting fixture can be obtained. Preferably, the recess is open in the lighting direction to form the aperture, wherein the light source is arranged to emit the light beam in the lighting direction. This way, an even more compact rail lighting fixture can be obtained.

By for instance emitting a divergent light beam, the lighting fixture can efficiently illuminate the rail and/or a path along the rail. According to a preferred embodiment of the rail lighting fixture, the light beam directed by the lighting fixture has an asymmetric light distribution, wherein a horizontal light distribution of the light beam is wider than a vertical light distribution of the light beam. That is, if the lighting fixture is attached to, e.g., a horizontal rail to illuminate a horizontal path, the lighting fixture preferably has such an asymmetric light distribution, wherein a horizontal beam angle is wider than a vertical beam angle. The light distribution is for instance oval-shaped. By limiting the vertical beam angle relative to the horizontal beam angle, blinding of a person can be further reduced.

To that end, the aperture is preferably provided with an optical element. The optical element may be arranged to receive the light beam emitted by the light source and to create the asymmetric light distribution. The optical element is for instance a lens. Alternatively, to create the asymmetric light distribution, the aperture may be shaped asymmetrically in a corresponding manner.

Additionally, or alternatively, the optical element may be arranged to receive the light beam emitted by the light source and to direct the light beam towards diverging directions. That is, the optical element may be arranged to direct the light beam through the aperture such that the light beam diverges.

To illuminate the path along the rail more efficiently, the aperture is preferably orientated away from the rail. More specifically, the aperture preferably has an optical axis extending, as seen in the horizontal plane, at an acute angle with the longitudinal or lighting direction and away from the rail as seen along the lighting direction. As such, the aperture is preferably orientated away from the rail as seen in the horizontal plane. The horizontal plane can be defined as the plane extending through the longitudinal direction of the rail and the lighting direction. Similarly, if the railway track comprises two parallel rails, the horizontal plane can be defined as the plane extending through the two rails. Preferably, the acute angle is at least 10, 20 or 25 degrees and/or less than 85, 70, 60, 50 or 45 degrees, for example about 30 degrees. Preferably, the acute angle is in the range of 30 to 70 degrees, preferably 40 to 65 degrees, for instance 45 or 60 degrees. The optical axis is preferably the optical axis of the optical element provided in the aperture.

According to a further preferred embodiment, the rail lighting fixture comprises fastening means arranged for attaching the housing to the rail. Preferably, the fastening means comprise a mounting bracket arranged for connecting the housing to the rail. The mounting bracket is preferably arranged for coupling with the rail, wherein the mounting bracket is further arranged to engage the housing. The mounting bracket may be further arranged to press the housing against the rail. Additionally, or alternatively, the housing may be provided with a fastening opening for coupling the mounting bracket to the housing. For instance, the fastening opening is threaded or provided with an internally threaded insert, wherein the mounting bracket can be screwed to the housing. Additionally, or alternatively, the housing may be provided with a notch arranged to receive the mounting bracket in a secure manner.

A further preferred embodiment of the rail lighting fixture comprises a heatsink body arranged to cool the at least one light source. This allows the rail lighting fixture to be more compact. The heatsink body preferably comprises aluminium. Preferably, the heatsink body forms part of the side of the housing facing the rail when the housing is attached to the rail. This way, cooling of the light source is enhanced.

The heatsink body may be manufactured by extrusion. Thereto, the heatsink body preferably comprises a fixed cross-sectional profile. Particularly when the heatsink body is arranged on the side facing the rail, the cross-sectional profile can be simplified such that the extrusion process is facilitated.

To simplify the manufacture of the lighting fixture and/or to enable customisability of the lighting fixture, the housing is preferably modular. Thereto, according to a further preferred embodiment of the rail lighting fixture, the housing comprises a first housing part and at least a second housing part releasably coupled to the first housing part. Preferably, the housing parts are essentially identical in shape, wherein each housing part is preferably provided with an aperture.

Preferably, the heatsink body is arranged to couple the housing parts. This way, additional fastening elements may be redundant such that the number of lighting fixture components can be minimised.

According to a further preferred embodiment of the rail lighting fixture, the housing is less than 4 centimetres, preferably less than 3 centimetres, in width as seen from the lighting direction. That is, the width direction may be the horizontal direction perpendicular to a horizontal rail. This allows the head flange of a common rail having an I-shaped cross-section to extend in a width direction at least as far as the housing of the lighting fixture, when the housing of the lighting fixture is attached to the web of the rail. As such, protection is enhanced.

For attachment to a variety of common rail types, according to a further preferred embodiment of the lighting fixture, the housing is less than 20 centimetres, preferably less than 10 centimetres, in height as seen from the lighting direction. That is, the height direction may be the vertical direction relative to a horizontal rail.

To provide a compact rail lighting fixture, according to a further preferred embodiment of the lighting fixture, the housing is less than 40 centimetres in length, preferably less than 20 centimetres, more preferably less than 10 centimetres.

A further preferred embodiment of the rail lighting fixture comprises electrical connectors connected to the at least one light source and arranged for connecting to a power source to connect the at least one light source to the power source for powering the at least one light source. For instance, the light source may be powered at 24 V DC. Preferably, the electrical connectors comprise at least one male connector and at least one female connector. Preferably, in an array of the rail lighting fixtures, the male and female connectors of respective lighting fixtures are mutually arranged for interconnecting the male connector and the female connector of neighbouring lighting fixtures for electrically connecting the lighting fixtures in the array in series. This simplifies installation of the array of lighting fixtures along a rail and enables customisation of the number of rail lighting fixtures in the array. Preferably, the connectors at both ends of the array are then arranged for connecting to a power source. Although the light source may be powered at 24 V DC, it may be preferred to power the light source at 36 V DC, or higher, to enable the coupling of rail lighting fixtures over larger distances.

Furthermore, to enable the coupling of rail lighting fixtures over larger distances, the rail lighting fixtures in the array are preferably electrically connected in parallel. In general, it is preferred if the male and female connectors of respective lighting fixtures are mutually arranged for interconnecting the male connector and the female connector of neighbouring lighting fixtures for electrically connecting the lighting fixtures in parallel.

Preferably, the housing is provided with an electrically insulating layer, preferably at least two insulating layers, arranged to insulate the interior of the housing, in particular the electrical components in the housing, from the rail.

For attachment to a rail of a train track, the housing is preferably arranged to withstand forces and vibrations, resulting from a passing train, and a variety of weather conditions, including harsh weather. According to a further preferred embodiment of the rail lighting fixture, the housing is filled with resin. This way, the lighting fixture can be made more waterproof and/or more resistant to vibrations resulting for instance from a passing train to protect, e.g., electrical components of the lighting fixture.

In particular, to obtain a more waterproof and/or more vibration resistant rail lighting fixture, the housing is preferably provided with a filling opening arranged for filling the housing with resin.

According to another embodiment, the rail lighting fixture may be obtained by an insert moulding technique. More specifically, it is preferred if the housing is monolithically formed onto the one or more components of the rail lighting fixture that are provided in the housing, including the at least one light source, by the insert moulding technique. That is, the housing is monolithically formed, by an insert moulding technique, onto the at least one light source and any other components of the rail lighting fixture, such that the housing comprises a solidified material that at least partially covers the at least one light source and the respective other components of the rail lighting fixture that are provided in the housing. For example, the at least one light source may comprise a light emitting element and a printed circuit board supporting the light emitting element. By forming the housing onto the components, the housing can effectively insulate the components such as the printed circuit board.

According to another aspect, a method for manufacturing a rail lighting fixture, preferably according to any of the above embodiments, for providing illumination along a rail of a railway track is provided. The lighting fixture comprises a housing, arranged for attachment to the rail and provided with at least one aperture, and one or more components which are provided in the housing and include at least one light source arranged to emit a light beam, wherein the lighting fixture is arranged to direct the light beam through the aperture towards a lighting direction. The method comprises the steps of:
providing a mould shaped for manufacturing the housing of the rail lighting fixture;
providing the one or more components of the rail lighting fixture in the mould;
injecting a liquid, such as a resin or molten material, into the mould and onto the one or more components to form the housing enclosing the one or more components.
   The components may further include the heatsink body for cooling the at least one light source.

Using an insert moulding technique, the lighting fixture can be manufactured more efficiently compared to first manufacturing the housing or parts thereof, for instance by additive manufacturing, and subsequently assembling the housing with the components of the rail lighting fixture.

The mould is preferably a two-part mould for convenient placement of the components in the mould cavity.

Preferably, the mould is made of silicone.

To accurately position the components in the mould and/or to ensure that the components remain in place during the moulding in a stable manner, the components are preferably mounted onto an inner frame of the rail lighting fixture. By connecting the components to the frame prior to insertion of the components into the mould, the components can be efficiently positioned in the mould. As such, it is preferred if the method further comprises the steps of providing an inner frame of the rail lighting fixture and mounting the one or more components onto the inner frame prior to inserting the components into the mould, wherein it is further preferred if the step of providing the one or more components in the mould comprises inserting the components mounted onto the inner frame into the mould.

The step of providing the one or more components in the mould preferably further comprises providing at least one removable cover in the mould at the location of the at least one aperture to be provided in the housing, wherein the method further comprises the step of removing the at least one cover after injecting the liquid to form the at least one aperture in the housing. By covering each aperture, specifically the optical element thereof, during the moulding, the liquid can be prevented from fully enclosing the optical element and, more in general, the housing can be efficiently provided with the at least one aperture. Similarly, each electrical connector can be partially covered during the moulding to prevent the liquid from fully enclosing the electrical connector, such that the connector is directly accessible and connectable after moulding.

The housing of the rail lighting fixture is preferably attached to a rail having an I-shaped cross-section. As such, a rail lighting system for providing illumination along a rail of a railway track is further provided, wherein the rail lighting system comprises at least one rail lighting fixture, preferably according to any of the embodiments described herein, wherein the lighting fixture comprises a housing, arranged for attachment to the rail and provided with at least one aperture, and at least one light source provided in the housing and arranged to emit a light beam, wherein the lighting fixture is arranged to direct the light beam through the aperture towards a lighting direction. Preferably, the lighting direction has a component that is parallel to a longitudinal direction of the rail.

According to yet another aspect, a presence detector for detecting a presence of a person alongside of a rail of a railway track is provided, wherein the presence detector is arranged to provide a presence detection signal indicative for the presence of a person alongside of the rail. For instance, the detector may sense a presence and/or motion from which, using an algorithm, it can be determined whether the sensed presence and/or motion is that of a person or, e.g., of an animal or an object alongside of the rail, such as vegetation. This way, it can be prevented that the presence detection signals indicate a presence of an animal or object without the presence of a person, also referred to as false positives.

In case the rail lighting system is provided with such a presence detector, the system may be arranged to control, based on the presence detection signal, an illumination intensity of the light source of the at least one lighting fixture at a first illumination intensity when the presence detection signal indicates the presence of a person alongside of the rail, and at a second illumination intensity when the presence detection signal does not indicate the presence of a person alongside of the rail, wherein the first intensity exceeds the second intensity. For instance, the second intensity may be in the range of 5 to 70 percent, preferably 10 to 50 percent, of the first intensity. To control the illumination intensity based on the presence detection signal, the rail lighting system or the presence detector may comprise a controller arranged to that end.

By turning off or dimming the light, the system can be made more energy efficient. It is possible to provide one or more further illumination intensities, such as a third and a fourth illumination intensity, in dependence of the circumstances such as the amount of daylight. In general, it is preferred if the path along the rail is sufficiently illuminated whenever a person is to walk said path, particularly for safety. For instance, during the day, when there is sufficient sunlight, the lighting may be turned off, only to turn on when dusk falls. Then, the system can be configured such that the illumination of the path is increased when a person is present. Optionally, the system is arranged to decrease the illumination after a predefined delay time from the moment the presence of a person is detected or the moment from which the presence of the person is no longer detected. The predefined delay time is, e.g., between 10 and 100 minutes, preferably between 20 and 50 minutes. The illumination intensity may change from one intensity to the other either gradually or in one step.

Specifically, the presence detector may comprise a wave transmitter arranged to emit an electromagnetic wave for reflection by a person, a wave receiver arranged to receive the electromagnetic wave reflected by the person, and a processor connected to the wave receiver and arranged to provide the presence detection signal based on the received electromagnetic wave. The controller may then be connected to the processor to receive the presence detection signal. Preferably, the electromagnetic wave is a microwave or a radio wave. In the rail lighting system or, more in general, in any outdoor environment, radar detection has been found to be more suitable than, e.g., a passive infrared sensor for presence detection.

It is preferred if the presence detector is arranged to direct the emitted electromagnetic wave to a detection region alongside of the rail. This way, it can be ensured that the path along the rail is illuminated when the person is present on the path along the rail. It is then further preferred if the presence detector is arranged to direct the emitted electromagnetic wave to only the detection region, in order to further prevent the presence detection signals from indicating a presence of an animal or object not located on the path.

The detection region is thus preferably limited and may extend, as seen in the horizontal plane, between the rail and a detection region boundary spaced from the rail. The width of the detection region may be at least 1 metre and/or less than 5 or 2 metres. Lengthwise, as seen along the rail, the detection region may be at least 1 metre and/or less than 6 or 3 metres. The height of the detection region may be at least 1 metre and/or less than 3 metres.

The presence detector may comprise a sensor housing arranged for attachment to the rail. The sensor housing may be distinct from the housing of the rail lighting fixture. The wave emitter, the wave receiver and the processor are preferably provided in the sensor housing. Preferably, the sensor housing corresponds to the housing of the rail lighting fixture. That is, the housing of the detector is preferably similarly shaped or identical to the housing of the rail lighting fixture as described above. The presence detector may be arranged to direct the emitted electromagnetic wave away from the rail to the detection region, i.e., when the sensor housing is attached to the rail.

The rail lighting system may further comprise a power source connected to the at least one light fixture and arranged to power the light source of the at least one lighting fixture, wherein the rail lighting system is arranged to control the power provided to the light source by the power source in dependence of the presence detection signal. Preferably, the power source is further arranged to power the presence detector.

Similar to the rail lighting fixture, the presence detector preferably comprises electrical connectors arranged for connecting to a power source to connect the presence detector to the power source for powering the presence detector, in particular the wave transmitter, the wave receiver and the processor. For instance, the presence detector may be powered at 24 or 36 V DC, similar to the rail lighting fixture. Preferably, the electrical connectors comprise a male connector and a female connector.

The rail lighting system may further comprise the rail, wherein the rail has an I-shaped cross-section, wherein the housing of the lighting fixture is attached to the rail. Preferably, a head flange of the rail extends in a width direction at least as far as the housing of the lighting fixture for protecting the lighting fixture.

Preferably, the rail lighting system comprises an array of the rail lighting fixtures as described herein, wherein the lighting fixtures are attached along the rail at intervals, preferably such that a substantially uniform illumination along the rail is provided. In this case, it is preferred if the rail lighting system is arranged to control the illumination intensity of each lighting fixture in the array simultaneously. The path along the rail may be illuminated by consecutive arrays of the lighting fixtures, wherein each array is controlled independently by at least one distinct presence detector. A presence detector associated with a first array of lighting fixtures may be installed between two lighting fixtures of the first array or at an end of the first array, for instance between the first array and an adjacent second array attached to the rail consecutive to the first array.

Preferably, in an array of the rail lighting fixtures, the male and female connectors of the presence detector are arranged for connecting, on either side, to respectively the female connector and the male connector of neighbouring lighting fixtures for electrically connecting the presence detector and the lighting fixtures in the array. In general, for customisability it is preferred if the presence detector can be connected via the same electrical connector cables as the lighting fixtures. The presence detector and the rail lighting fixtures in the array, specifically their connectors, are preferably connected via five-pin electrical connector cables. Four pins of such a cable can then enable the lighting fixtures and the presence detectors to be conveniently interconnected in an array and electrically connected in parallel. The fifth pin allows the lighting fixtures to be controlled based on the presence detection signal.

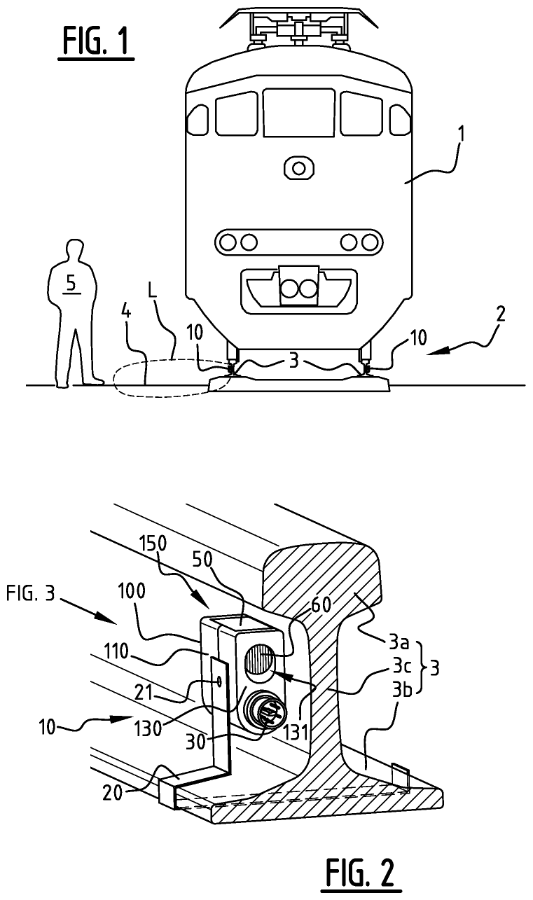

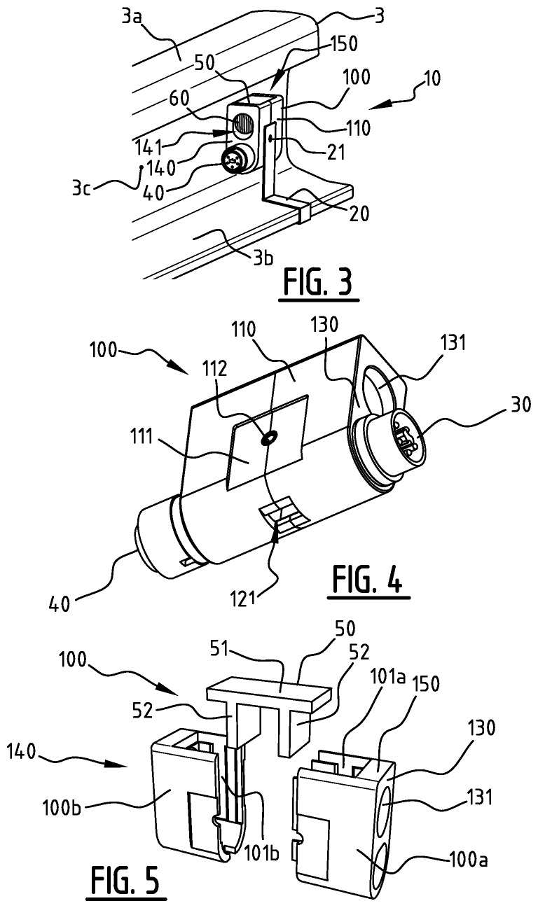

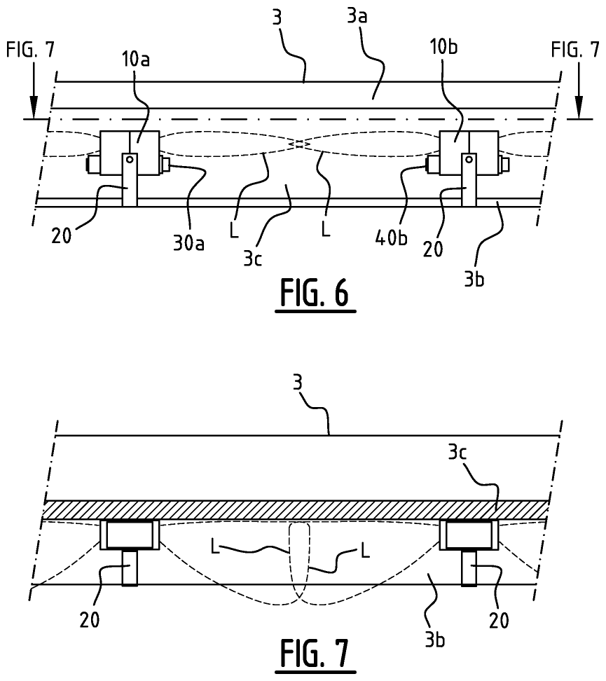

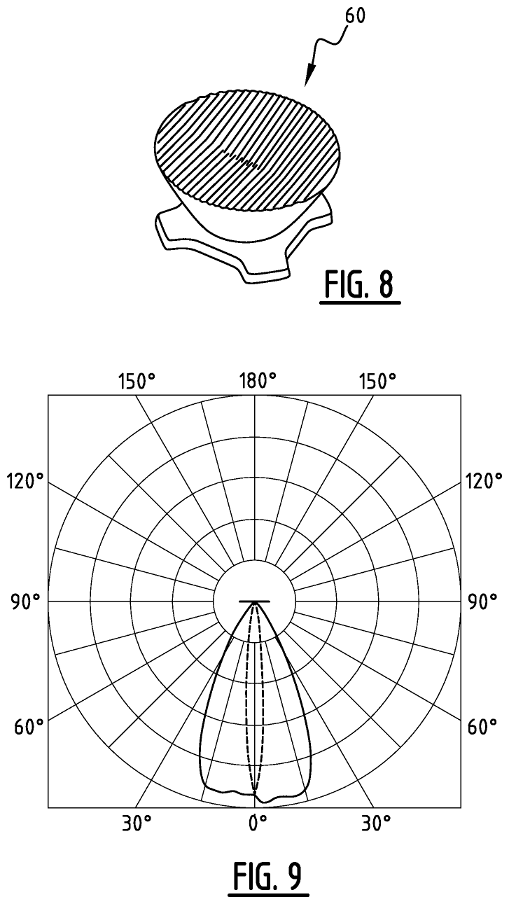

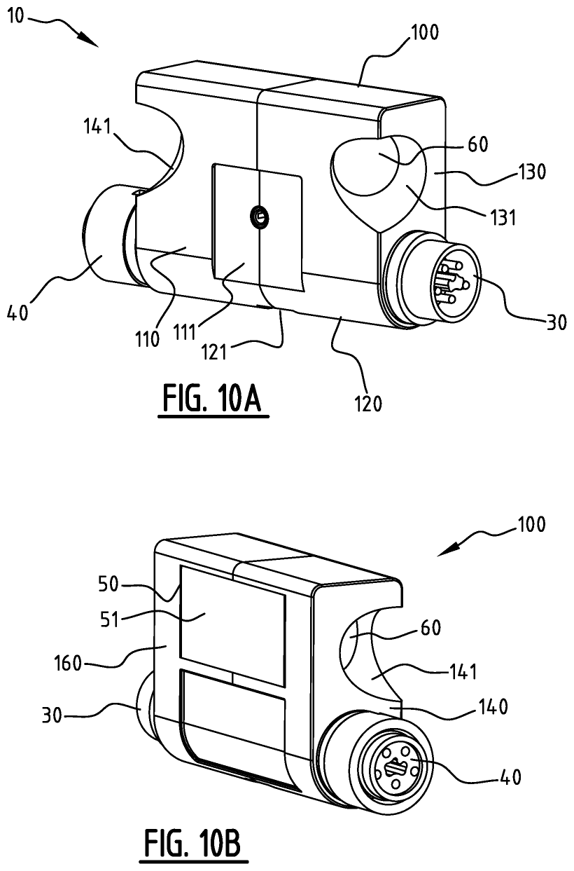

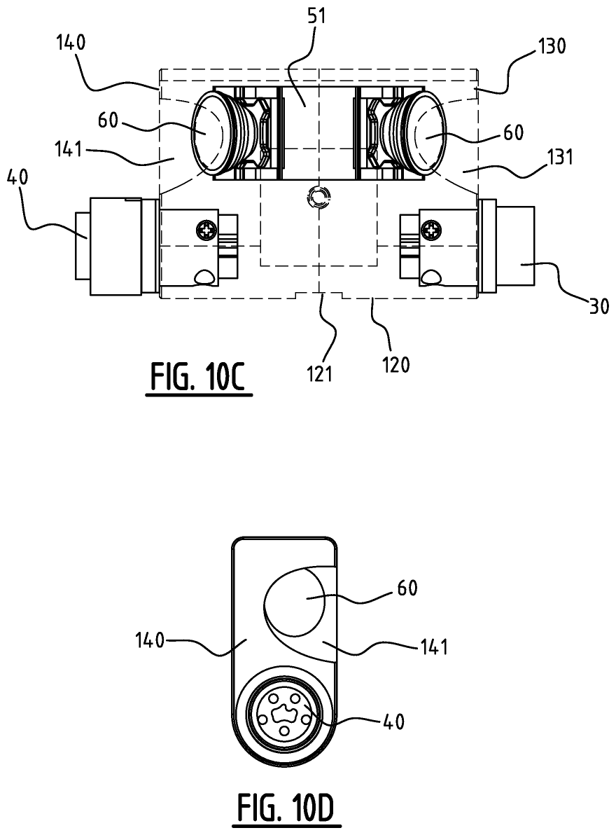

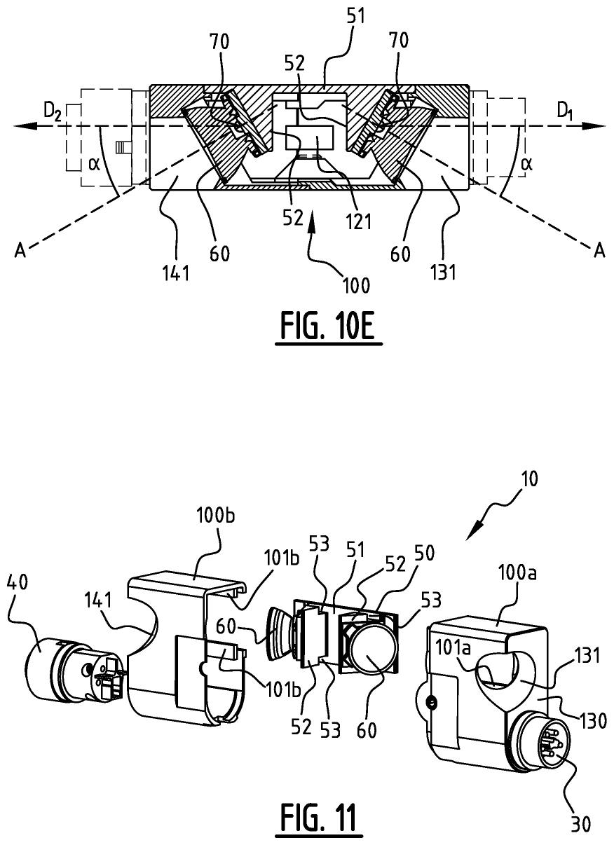

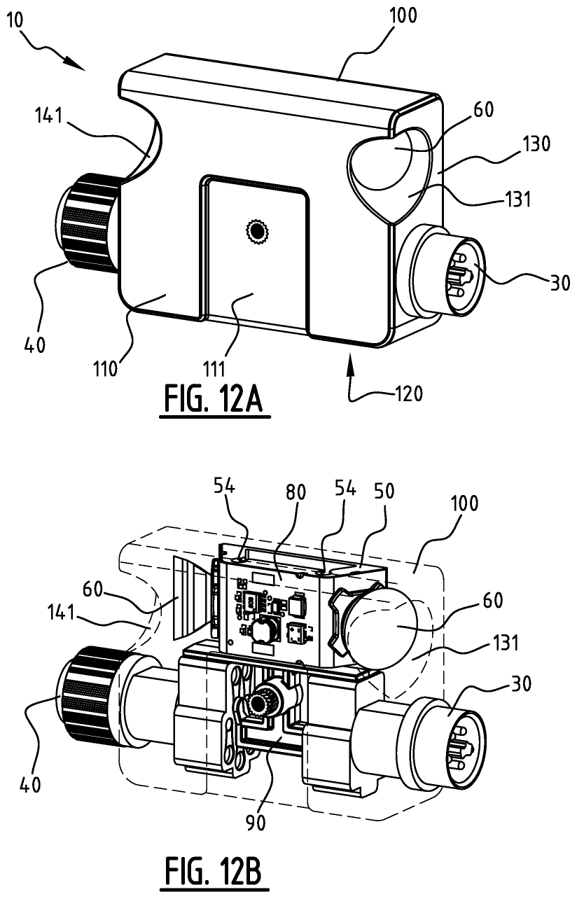

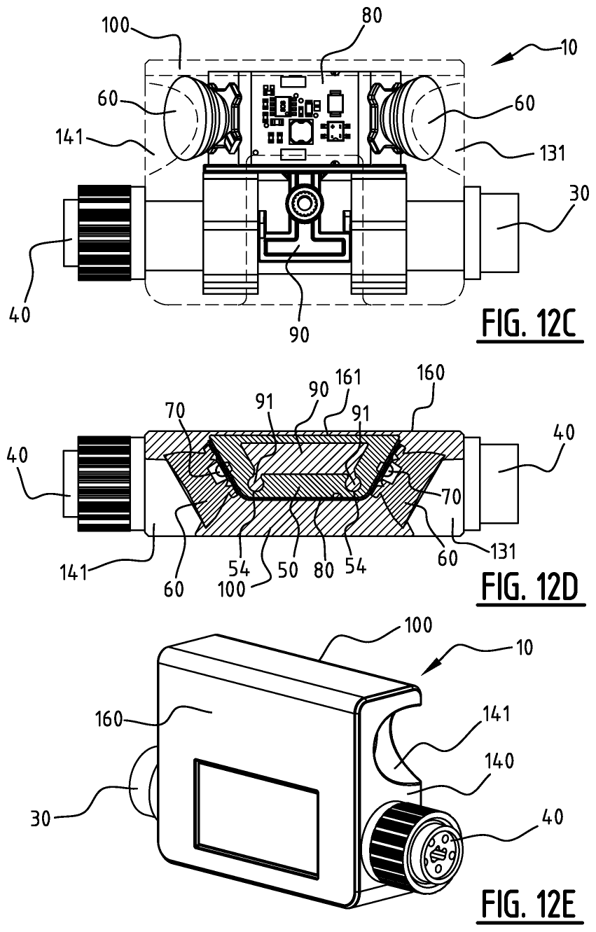

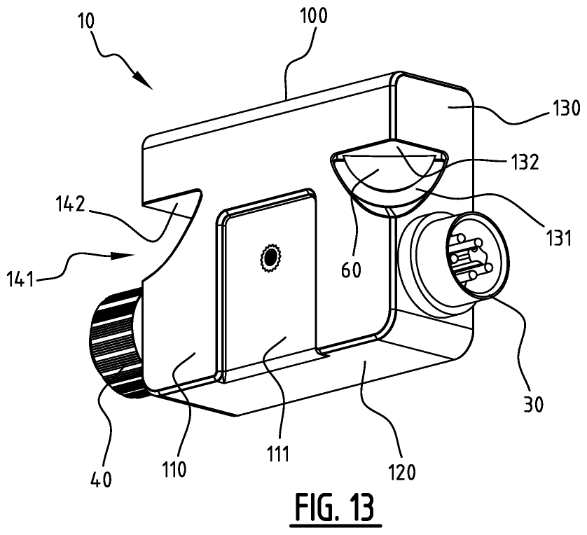

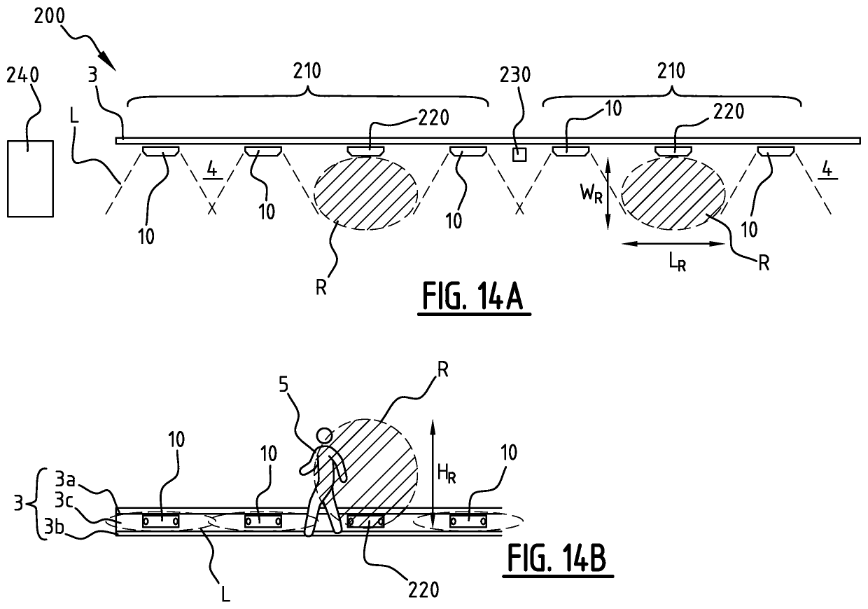

The present invention is hereinafter further elucidated with reference to the attached drawings, wherein:
FIG. 1 represents a front view of a train on a railway track;
FIG. 2 shows a front view of a rail lighting fixture attached to a rail;
FIG. 3 shows a back view of the rail lighting fixture as shown in FIG. 2;
FIG. 4 shows a bottom view of the housing of the rail lighting fixture of FIGS. 2 and 3;
FIG. 5 represents an exploded view of the housing shown in FIG. 4;
FIG. 6 shows a side view of two rail lighting fixtures attached consecutively to a rail;
FIG. 7 shows a top view of the two rail lighting fixtures as shown in FIG. 6;
FIG. 8 shows a lens;
FIG. 9 represents a light distribution diagram associated with the lens shown in FIG. 8;
FIGS. 10A-E show various views of a further embodiment of the rail lighting fixture;
FIG. 11 represents an exploded view of the lighting fixture shown in FIGS. 10A-E;
FIGS. 12A-E show various views of a further embodiment of the rail lighting fixture;
FIG. 13 represents a further embodiment of the rail lighting fixture;
FIGS. 14A-B show different views of a rail lighting system with presence detectors.

In the drawings of the different embodiments, like elements are indicated by like reference signs.

FIG. 1 depicts a front view of a train 1 on a railway track 2 formed by two parallel flat-bottomed rails 3. Each rail 3 has an I-shaped cross-section. Rail lighting fixtures 10 are attached to the rails 3 and arranged to provide illumination along the train track 2. To illustrate, an oval-shaped light distribution L, illuminating a walking path 4 along the train track 2 such that blinding of a person 5 near the track 2 is minimised, is indicated in FIG. 1 for one side of the track 2. More specifically, the light beam L emitted by the lighting fixture 10 diverges and is thereby partially directed away from the rail 3 to illuminate the walking path 4 over a sufficient width of the path 4. Additionally, the rail 3 is partly illuminated, such that the walking path 4 is also illuminated indirectly via the rail 3.

Each rail lighting fixture 10 is attached to the web 3c of the respective rail 3, as can be seen enlarged in FIGS. 2 and 3, showing a front view and a back view of a single rail lighting fixture 10. The rail lighting fixture 10 comprises a housing 100 attached sideways to the rail 3. The width W of the housing 100 is preferably less than the extent to which the head flange 3a of the rail 3 protrudes from the web 3c in the width direction, such that the head flange 3a of the rail 3 extends in the width direction at least as far as the housing 100 of the lighting fixture 10 attached to the rail 3. To connect the lighting fixture 10 to the rail 3, the rail lighting fixture 10 comprises a mounting bracket 20 coupled to the foot flange 3b of the rail 3. As shown in FIG. 4, the side 110 of the housing 100 is provided with a notch 111, in which the mounting bracket 20 is received as shown in FIGS. 2 and 3, and the bottom 120 of the housing 100 is provided with a filling opening 121 for filling the housing 100 with resin. The mounting bracket 20 is provided with a screw opening 21 for screwing the mounting bracket 20 to the housing 100 by means of a threaded hole 112 in the housing 100 that is located in the notch 111 and aligned with the screw opening 21 of the mounting bracket 20.

Referring to FIGS. 2 and 3, at least one LED (not shown) is provided in the housing 100. A front side 130 and a back side 140 of the housing 100 are each provided with an aperture 131, 141, such that a light beam, emitted by the LEDs in mutually opposite lighting directions parallel to a longitudinal direction of the rail 3, is directed through the apertures 131, 141. The rail lighting fixture 10 comprises electrical connectors 30, 40 electrically connected to the LEDs. The front side 130 is provided with a male connector 30 and the back side 140 is provided with a female connector 40. The connectors 30, 40 are arranged for connecting the LEDs, for instance via electrically conducting cables (not shown), to a power source such as a battery (not shown).

In FIG. 5, modularity of the rail lighting fixture 10 is illustrated in exploded view. More specifically, the housing 100 comprises a front housing part 100a, including the front side 130 of the housing 100, and a back housing part 100b, including the back side 140 of the housing 100. The rail lighting fixture 10 comprises an aluminium heatsink body 50 arranged to cool the LEDs. The heatsink body 50 comprises a top portion 51 forming part of a top side 150 of the housing 100. The heatsink body 50 further comprises protrusions 52 extending from the top portion 51 into the housing 100 to couple the housing parts 100a, 100b by arranging the protrusions 52, in particular in a sliding manner, into corresponding grooves 101a, 101b formed inside the respective housing parts 100a, 100b. The housing 100 can be disassembled by moving the protrusions 52 out of the grooves 101a, 101b.

FIGS. 6 and 7 show respectively a side view and a top view of two consecutive rail lighting fixtures 10a, 10b that are part of an array of rail lighting fixtures attached along a rail 3 at intervals. To illuminate the path along the rail 3 uniformly, the illumination distributions L provided by the respective lighting fixtures 10a, 10b partially overlap. The male connector 30a of a rail lighting fixture 10a in the array is arranged opposite the female connector 40b of the consecutive rail lighting fixture 10b in the array for interconnecting the connectors 30a, 40b, for instance by means of a power cable (not shown), for electrically connecting the lighting fixtures 10a, 10b in the array in series. The connectors at both ends of the array (not shown) are arranged for connecting to a power source (not shown).

To obtain an oval-shaped light distribution L as shown in FIG. 1 and as illustrated by the combination of FIGS. 6 and 7, each aperture 131, 141 is provided with an optical element 60, as shown in FIGS. 2 and 3, for creating an asymmetric light distribution L. The optical element 60 may be a non-imaging Fresnel lens as shown in FIG. 8. The lens 60 is designed to create the asymmetric light distribution as illustrated by the light distribution diagram represented by FIG. 9, wherein a horizontal light distribution (indicated by the continuous curve) is wider than a vertical light distribution (indicated by the dashed curve).

FIGS. 10A-E and 11 relate to an alternative embodiment of the rail lighting fixture 10. The lighting fixture 10 comprises a housing 100, arranged for attachment to a rail 3 of a railway track 2 as in FIG. 1. The side 110 of the housing 100 is provided with a notch 111, in which a mounting bracket can be received as described above. The bottom 120 of the housing 100 is provided with a filling opening 121 for filling the housing 100 with resin.

A front side 130 and a back side 140 of the housing 100 are each provided with an aperture 131, 141. Relative to the embodiment shown in FIGS. 2-5, the apertures 131, 141 are orientated slightly away from the rail 3 as seen in the horizontal plane, as further elucidated as follows. The lighting fixture 10 further comprises two LEDs 70, provided in the housing 100 and respectively associated with the two apertures 131, 141 as shown in FIG. 10E, and electrical connectors 30, 40 electrically connected to the LEDs 70. Each LED 70 is arranged to emit a light beam. Each aperture 131, 141 is provided with an optical element 60 arranged to receive the light beam emitted by the respective LED 70 and emit a diverging light beam.

FIG. 10E represents a top view of a horizontal cross-section of the lighting fixture 10. The optical element 60 is arranged to direct the light beam towards diverging directions, including a lighting direction D1, D2 parallel to a longitudinal direction of the rail 3. The optical axis A of the optical element 60 extends at a 30-degree angle with the longitudinal direction of the rail 3. As such, the optical axis A extends at an acute angle a with the lighting direction D1, D2 and away from the rail 3 as seen along the lighting direction D1, D2. In a preferred embodiment, the optical axis A extends at a 45-degree angle with the longitudinal direction of the rail 3.

In FIG. 11, the rail lighting fixture 10 is depicted in exploded view. The housing 100 comprises a front housing part 100a, including the front side 130 of the housing 100, and a back housing part 100b, including the back side 140 of the housing 100. The rail lighting fixture 10 comprises an aluminium heatsink body 50 arranged to cool the LEDs 70. The heatsink body 50 comprises a main portion 51 forming part of the side 160 of the housing 100 facing the rail 3 when the housing 100 is attached to the rail 3. The heatsink body 50 further comprises notched protrusions 52 extending from the main portion 51 into the housing 100. Corresponding flanges 101a, 101b are formed inside the respective housing parts 100a, 100b to couple the housing parts 100a, 100b by sliding the flanges 101a, 101b into the notches 53 of the protrusions 52.

FIGS. 12A-E relate to yet another embodiment of the rail lighting fixture 10. The lighting fixture 10 comprises a monolithic housing 100, arranged for attachment to a rail 3 of a railway track 2 as in FIG. 1. A front side 130 and a back side 140 of the housing 100 are respectively provided with apertures 131, 141 orientated slightly away from the rail 3 as seen in the horizontal plane, as in the embodiment shown in FIGS. 10A-E and 11.

Specifically, FIG. 12D represents a top view of a horizontal cross-section of the lighting fixture 10. The lighting fixture 10 further comprises two LEDs 70 mounted on a printed circuit board 80 (or, alternatively, on respective printed circuit boards). The LEDs 70 are provided in the housing 100 and respectively associated with the two apertures 131, 141. Electrical connectors 30, 40 of the lighting fixture 10 are electrically connected to the LEDs 70 via the printed circuit board 80. The rail lighting fixture 10 further comprises an aluminium heatsink body 50 arranged to cool the LEDs 70 and the printed circuit board 80, which is attached (e.g., glued) onto the heatsink body 50. Instead of the heatsink body 50 forming part of the side 160 of the housing 100 facing the rail 3 when the housing 100 is attached to the rail 3 (as in the embodiment shown in FIGS. 10A-E and 11), the heatsink body 50 is insulated by a layer 161 of the housing 100 of 1-3 millimetres that forms part of said side 160.

The rail lighting fixture 10 shown in FIGS. 12A-E is manufactured by insert moulding. Hereto, the heatsink body 50 is attached or clamped onto an inner frame 90 of the lighting fixture 10, specifically by arranging protrusions 91 of the frame 90, particularly in a sliding manner, into corresponding grooves 54 formed in the heatsink body 50. In addition, the electrical connectors 30, 40 are coupled to the frame 90, and the printed circuit board 80 supporting LEDs 70 and lenses 60 is glued to the heatsink body 50. The assembly of the rail lighting fixture components, including the connectors 30, 40, the heatsink body 50, the lenses 60, the LEDs 70, and the printed circuit board 80, all mounted on the frame 90, is inserted into in the cavity of a two-part mould (not shown) that is shaped for manufacturing the housing 100. Here, it is ensured that the lenses 60 and the connectable part of the electrical connectors 30, 40 are covered in the subsequent moulding step, in which a molten material, or a resin, is injected into the mould, such that the lenses 60 and the connectable part of the electrical connectors 30, 40 are shielded from the molten material. The molten material injected into the mould is injected onto the components to form the housing 100 enclosing the components. When the housing 100 is formed and solidified around the components, the rail lighting fixture 10 is ejected from the mould and the lenses 60 and the connectors 30, 40 are uncovered. By covering the lenses 60 and the connectors 30, 40 during moulding as described herein, the housing 100 is provided with the apertures 131, 141 for the lenses 60, and the connectors 30, 40 are directly accessible and connectable after moulding.

FIG. 13 relates to yet another embodiment of the rail lighting fixture 10, like the embodiment shown in FIGS. 12A-E. The optical axes of the respective optical elements 60 each extend, when the lighting fixture 10 is installed to a rail 3 as in FIG. 1, at a 45-degree angle with the longitudinal direction of the rail 3 as seen in the horizontal plane.

Furthermore, the apertures 131, 141, specifically an upper segment thereof, are defined by respective upper edges 132, 142, that are preferably part of the housing 100. The upper edges 132, 142 are configured, or shaped, to limit the vertical light distribution of the light beam emitted from the respective aperture 131, 141. Specifically, the upper edges 132, 142 limit the upwards directed segments of the respective light beams. This way, the blinding of persons can be further reduced. In this case, the upper edges 132, 142 form an overhang, thereby covering the upper half of the optical elements 60.

FIGS. 14A and 14B schematically show respectively a top view and a side view of a rail lighting system 200 comprising a first and a second array 210 of rail lighting fixtures 10 attached to a flat-bottomed rail 3 of a railway track as shown in FIG. 1 (only one rail 3 is shown in FIGS. 14A-B), and arranged to illuminate a walking path 4 along the train track. Each rail 3 has an I-shaped cross-section. Each rail lighting fixture 10 is attached to the web 3c of the rail 3 and arranged to emit a diverging light beam and provide an asymmetric light distribution L. As such, the light beam is directed towards diverging directions, including a lighting direction with a component parallel to the rail 3.

The system 200 further comprises, for each array 210, a radar sensor 220 for detecting a presence of a person 5 alongside of the rail 3. The radar sensor 220 is attached to the rail 3 in a manner similar to the lighting fixtures 10 and arranged to emit a radio wave for reflection by a person 5, to receive the radio wave reflected by the person 5, and to provide a presence detection signal based on the received radio wave. The radar sensor 220 is arranged to direct the emitted radio wave away from the rail 3 to only a detection region R alongside of the rail 3, wherein the detection region R has a width W_{R} of about 1.5 metres, and a length L_{R} and a height H_{R} of 2 metres.

The rail lighting system 200 further comprises a controller (not shown) arranged to control an illumination intensity of each array 210 based on the presence detection signal provided by the respective radar sensor 220 associated with that array 210. The controller controls the lighting fixtures 10 such that they illuminate at full intensity when the presence detection signal indicates the presence of a person 5 alongside of the rail 3, and at a 20 percent intensity when the presence detection signal does not indicate the presence of a person 5 alongside of the rail 3. A splitter 230 installed between the consecutive arrays of lighting fixtures 10 enables the illumination intensity of each array 210 to be controlled independently from the illumination intensity of the other array. The controller is further arranged to decrease the illumination in one step after a predefined delay time of 30 minutes from the moment from which the presence of the person 5 is no longer detected.

The rail lighting system further comprises a power source 240 connected to the nearest lighting fixture 10 via a five-pin electrical connector cable (not shown). Each pair of neighbouring fixtures 10 is similarly interconnected by a five-pin electrical connector cable. Similarly, each radar sensor 220 is electrically connected to a neighbouring rail lighting fixture 10. Advantageously, all components of the rail lighting system 200 can be interconnected by a cable of the same type. Four pins of such a five-pin cable then enable the lighting fixtures 10 and the presence detectors 220 to be electrically connected in parallel. The lighting fixtures 10 can be controlled based on the presence detection signal via the fifth pin.

The figures and the above description serve to illustrate specific embodiments of the invention and do not limit the scope of protection defined by the following claims.

1. A rail lighting fixture for providing illumination along a rail of a railway track, wherein the lighting fixture comprises a housing, arranged for attachment to the rail and provided with at least one aperture, and at least one light source provided in the housing and arranged to emit a light beam, wherein the lighting fixture is arranged to direct the light beam through the aperture towards a lighting direction, wherein the lighting direction has a component that is parallel to a longitudinal direction of the rail, wherein:
the aperture is provided with an optical element arranged to receive the light beam and to direct the light beam towards diverging directions; or
the aperture has an optical axis extending, as seen in the horizontal plane, at an acute angle with the longitudinal direction and away from the rail as seen along the lighting direction.

2. The rail lighting fixture according to claim 1, wherein the lighting fixture is arranged to direct a first light beam and a second light beam towards mutually opposite lighting directions parallel to the longitudinal direction.

3. The rail lighting fixture according to claim 1, wherein the light beam directed towards the lighting direction has an asymmetric light distribution, wherein a horizontal light distribution of the light beam is wider than a vertical light distribution of the light beam.

4. The rail lighting fixture according to claim 3, wherein the optical element is arranged to create the asymmetric light distribution.

5. The rail lighting fixture according to claim 1, wherein the optical element is a lens.

6. The rail lighting fixture according to claim 1, further comprising fastening means arranged for attaching the housing to the rail.

7. The rail lighting fixture according to claim 6, wherein the fastening means comprise a mounting bracket arranged for connecting the housing to the rail, wherein the mounting bracket is arranged for coupling with the rail, wherein the mounting bracket is further arranged to engage the housing.

8. The rail lighting fixture according to claim 1, further comprising a heatsink body arranged to cool the at least one light source.

9. The rail lighting fixture according to claim 1, wherein the housing is monolithically formed, by an insert moulding technique, onto the at least one light source and any other components provided in the housing, such that the housing comprises a solidified material that at least partially covers the at least one light source and the respective other components of the rail lighting fixture that are provided in the housing.

10. The rail lighting fixture according to claim 1, wherein the housing is less than 4 centimetres in width as seen from the lighting direction.

11. The rail lighting fixture according to claim 1, wherein the housing is less than 40 centimetres in length.

12. The rail lighting fixture according to claim 1, wherein the housing is less than 20 centimetres in height as seen from the lighting direction.

13. A rail lighting system for providing illumination along a rail of a railway track, wherein the rail lighting system comprises at least one rail lighting fixture, according to any of the preceding claims, and a presence detector for detecting a presence of a person alongside of the rail, wherein the presence detector is arranged to provide a presence detection signal indicative for the presence of a person alongside of the rail, wherein the rail lighting system is arranged to control, based on the presence detection signal, an illumination intensity of the light source of the at least one lighting fixture at a first illumination intensity when the presence detection signal indicates the presence of a person alongside of the rail, and at a second illumination intensity when the presence detection signal does not indicate the presence of a person alongside of the rail, wherein the first intensity exceeds the second intensity.

14. The rail lighting system according to claim 13, wherein the presence detector comprises a wave transmitter arranged to emit an electromagnetic wave for reflection by a person, a wave receiver arranged to receive the electromagnetic wave reflected by the person, and a processor connected to the wave receiver and arranged to provide the presence detection signal based on the received electromagnetic wave.

15. The rail lighting system according to claim 14, wherein the presence detector comprises a sensor housing arranged for attachment to the rail, wherein the sensor housing is distinct from the housing of the rail lighting fixture, wherein the wave emitter, the wave receiver and the processor are provided in the sensor housing, and wherein the presence detector is arranged to direct the emitted electromagnetic wave away from the rail to a detection region alongside of the rail, preferably to only the detection region.

16. The rail lighting system according to claim 14, wherein the electromagnetic wave is a microwave or a radio wave.

17. The rail lighting system according to claim 13, further comprising a power source connected to the at least one light fixture and arranged to power the light source of the at least one lighting fixture, wherein the rail lighting system is arranged to control the power provided to the light source by the power source in dependence of the presence detection signal.

18. The rail lighting system according to claim 13, wherein the second intensity is in the range of 5 to 70 percent of the first intensity.

19. The rail lighting system according to claim 13, further comprising the rail, wherein the rail has an I-shaped cross-section, wherein the housing of the lighting fixture is attached to the rail, wherein a head flange of the rail extends in a width direction at least as far as the housing of the lighting fixture.

20. The rail lighting system according to claim 13, wherein the lighting system comprises an array of rail lighting fixtures, wherein the array of rail lighting fixture comprises a housing, arranged for attachment to the rail and provided with at least one aperture, and at least one light source provided in the housing and arranged to emit a light beam, wherein the lighting fixture is arranged to direct the light beam through the aperture towards a lighting direction, wherein the lighting direction has a component that is parallel to a longitudinal direction of the rail, wherein:
the aperture is provided with an optical element arranged to receive the light beam and to direct the light beam towards diverging directions; or
the aperture has an optical axis extending, as seen in the horizontal plane, at an acute angle with the longitudinal direction and away from the rail as seen along the lighting direction; and
wherein the lighting fixtures are arranged for attachment along the rail at intervals.

21-23. (canceled)
